(19) United States
(12) Patent Application Publication
(10) Pub. No.: US 2018/0137532 A1
(43) Pub. Date: May 17, 2018

(54) METHOD AND SYSTEM FOR DYNAMIC MULTI-CRITERIA LOYALTY PROGRAM REDEMPTIONS

(71) Applicant: Points.com Inc., Toronto (CA)

(72) Inventors: Christopher Boyd, Toronto (CA); Orion Wilks, Toronto (CA)

(21) Appl. No.: 15/353,175

(22) Filed: Nov. 16, 2016

(51) Int. Cl. G06Q 30/02

(52) U.S. Cl. CPC G06Q 30/0233; G06Q 30/0232

(57) ABSTRACT

A method and system for managing loyalty program redemptions under dynamic pricing considerations. The method is executed in a processor of a loyalty program management (LPM) server device. A redemption request including an associated asset spend is received from a client device. A plurality of loyalty program provider (LPP) server devices of respective loyalty program providers is accessed to obtain a set of discounted inventory items or services. Cost of redemptions to the loyalty program providers and perceived value to the redeeming member, as measured by perceived value indicators are determined based at least in part on the discounted item values and the asset spend associated with the redemption request. Based on applying a threshold value of the costs of redemption and the perceived value indicators, a qualifying subset of the discounted inventory items is identified. Embodiments recognize that conventional approaches identify solutions where minimizing or eliminating the costs of redemptions to the loyalty program providers are diametrically opposed to a goal of achieving and delivering maximum value to a redeeming member as measured by the perceived value indicators. In contrast, certain embodiments of the dynamic loyalty redemption methods and systems herein identify and provide solutions where, as the costs of redemptions to the loyalty program providers progressively decrease towards a zero cost, the perceived value to a redeeming member progressively increase, as measured by the perceived value indicators.

### TECHNICAL FIELD

Examples described herein relate to a system and method for loyalty program redemptions.

### BACKGROUND

Many modern consumers are members of one or more loyalty programs, under which benefits earned may be redeemed. Under the loyalty program, consumers are typically awarded, and can accumulate, “points”, “miles” or similar credit by purchasing products or services offered by the sponsor or provider of the loyalty program. A member who has accumulated a sufficient number of points or credit may redeem benefits under the program by exchanging same for products or services, consistent with offerings of the loyalty program sponsor or provider.

### BRIEF DESCRIPTION OF THE DRAWINGS

FIG. 1 illustrates a system for a dynamic loyalty program redemption system, according to some embodiments.

FIG. 2 illustrates an example architecture of a server device for implementing a dynamic loyalty program redemption system.

FIG. 3 illustrates an example method of operation of a dynamic loyalty program redemption system.

FIG. 4 illustrates an example instance of a solution set in operation of the dynamic loyalty program redemption system.

### DETAILED DESCRIPTION

Embodiments provided herein include a method and system for managing loyalty program redemptions, providing loyalty program redemption solutions that satisfy dynamically changing pricing and selection criteria. The method is executed in a processor of a loyalty program management (LPM) server device. A loyalty program redemption request specifying an asset spend is received from a client computing or communication device. The asset spend may include a number of loyalty program points accumulated by the redeeming member combined with a cash monetary portion to be paid by the member during a redemption operation. A plurality of loyalty program provider (LPP) server devices of multiple loyalty program providers, or program partners, is accessed to obtain pricing information related to inventory items or services, including discounted inventory items or services. The cost to a loyalty program provider when a member opts to redeem a given inventory item and perceived value indicators to a loyalty program customer regarding particular redemption options are determined dynamically, even when applying multiple criteria which the resultant redemption options must satisfy. The perceived value indicator is determined based at least in part on the redemption points portion of the asset spend. Based on applying respective threshold values of the costs of redemption to the loyalty program providers and the perceived value indicators, a qualifying or optimal subset of the discounted inventory items along with associated perceived value indicators and loyalty program sponsors or providers is identified. Among other technical effects and advantages, certain embodiments herein dynamically determine and identify redemption options which minimize, or even eliminate, any redemption cost to the loyalty program provider while simultaneously maximizing the perceived value, as measured by the perceived value indicator, to the redeeming member or end-user. In further embodiments, only subsets of inventory items that result in a zero redemption cost, or no redemption cost, to the loyalty program providers may be identified for presenting to the redeeming member.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, laptop computers, printers, digital picture frames, network equipment (e.g., routers), wearable devices, and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the various machines shown with embodiments of the invention include processor(s) and various forms of memory for holding data and instructions. Examples of computer-readable mediums include permanent memory storage devices, such as hard drives on personal computers or servers. Other examples of computer storage mediums include flash memory (such as carried on smartphones, multifunctional devices or tablets), portable storage units, such as CD or DVD units, and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of embodying such a program.

### System Description

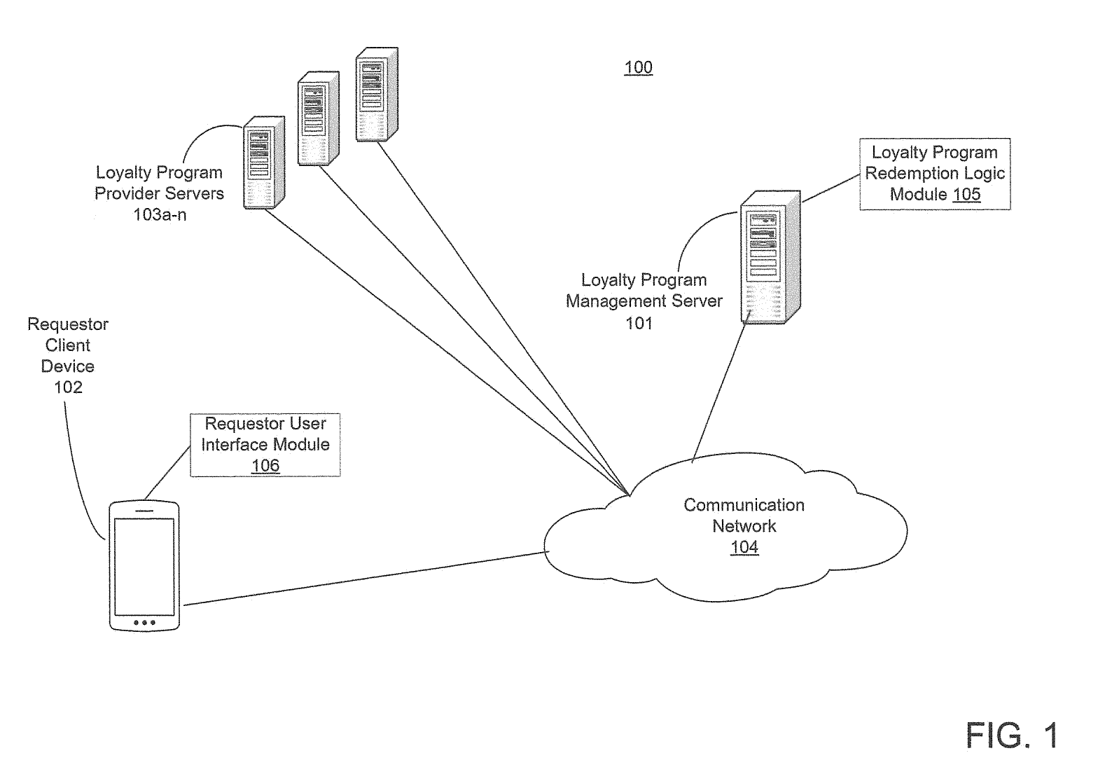

FIG. 1 illustrates dynamic loyalty program redemption system 100 in one embodiment. Loyalty program management (LPM) server 101 includes loyalty program redemption logic module 105 and is communicatively connected via communication network 104 to requestor client device 102 and to loyalty program provider (LPP) servers 103a-n of respective providers or sponsors of the loyalty program. Requestor client device 102 may be a computing and communication device for implementing a client requestor user interface in a dynamic loyalty program redemption system. As used herein, a client requestor device, and/or a computing device refer to devices corresponding to desktop computers, cellular devices or smartphones, laptop computers, tablet devices, wearable electronic devices, television (IP Television), etc., that can provide network connectivity and processing resources for communicating with the system 100 over a network. Requestor client device 102, also referred to variously herein as client device 102 and requestor device 102, includes requestor user interface module 106. In one embodiment client requestor device 102 may correspond to, for example, a cellular communication device (e.g., feature phone, smartphone etc.) that is capable of telephony, messaging, and/or data services. Client requestor device 102 may include a processor, a memory, a display screen, input mechanisms such as a keyboard or software-implemented touchscreen input functionality, location determination capability such as by way of a GPS module, and a communication interface for communicatively coupling to communication network 104, such as by sending and receiving cellular data over data channels and voice channels. Requestor user interface module 106 includes instructions stored in the memory, and provides a client requestor interface rendered at a display screen for interacting with LPM server 101 within dynamic loyalty program redemption system 100. In embodiments, requestor user interface module 106 may be an application program provided for use in conjunction with dynamic loyalty program redemption system 100, and may be stored in a memory of requestor device 102. In other embodiments, the application program that provides the functionality of requestor user interface module 106 may be downloaded from LPM server 101.

Requestor user interface module 106 may enable a user at client requestor device 102 to make a redemption request that specifies an associated asset spend to LPM server 101 within dynamic loyalty program redemption system 100. In one embodiment, the asset spend associated with the redemption request may be an amount of points, or travel miles, cumulatively earned and available for spending or exchanging related to the redemption request, and may also include a cash monetary portion to be paid by the member. The redemption request may also specify a class of inventory items to which it is targeted, such as, but not limited to, a travel ticket, a hotel room, a rental vehicle, a gift card or a merchandise item.

In embodiments, any number of individual loyalty program provider servers 103a-n (where n represents a positive integer greater than 1) may be maintained by respective loyalty program sponsors or providers. Loyalty program provider servers 103a-n may host respective loyalty program inventory offerings of items and services for redemption by loyalty program members or customers.

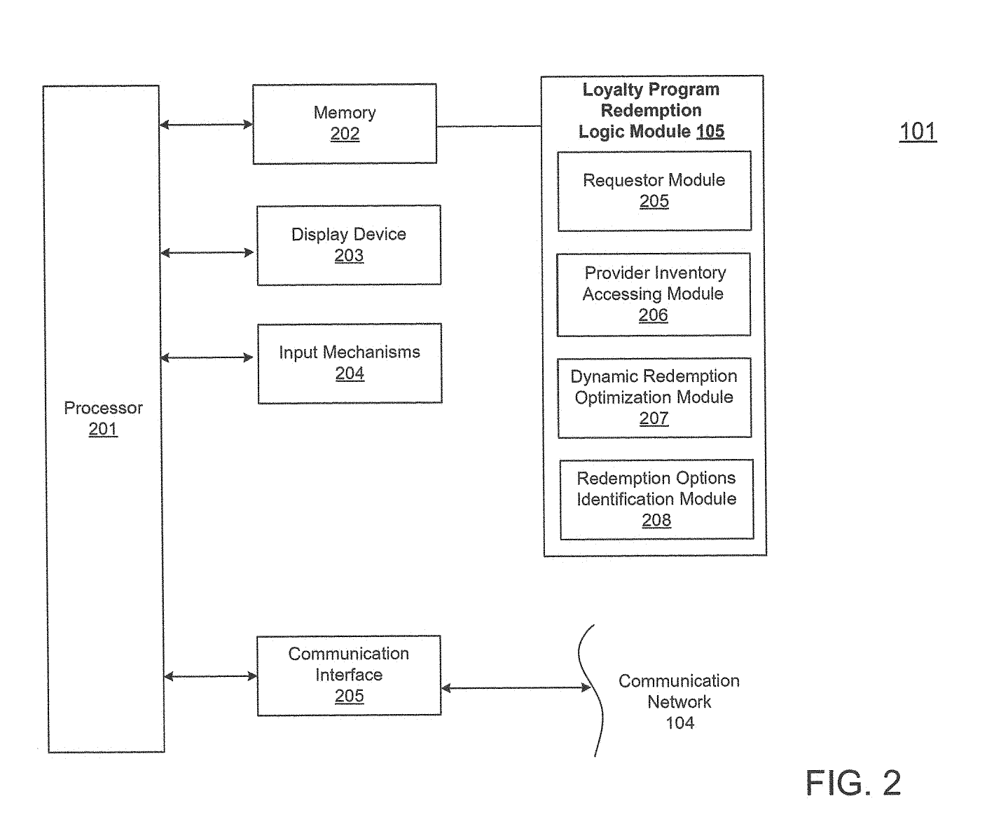

FIG. 2 illustrates an example architecture of LPM server 101 for implementing an embodiment of dynamic loyalty program redemption system 100. LPM server 101, in an embodiment architecture, may be implemented on one or more server devices, and includes processor 201, memory 202 which may include a read-only memory (ROM) as well as a random access memory (RAM) or other dynamic storage device, display device 203, input mechanisms 204 and communication interface 205 for communicative coupling to communication network 104. Processor 201 is configured with software and/or other logic, such as from loyalty program redemption logic module 105, to perform one or more processes, steps and other functions described with implementations, such as described by FIGS. 1 through 3 herein, and elsewhere in the application. Processor 201 may process information and instructions stored in memory 202, such as provided by a random access memory (RAM) or other dynamic storage device, for storing information and instructions which are executable by processor 201. Memory 202 also may be used for storing temporary variables or other intermediate information during execution of instructions to be executed by processor 201. Memory 202 may also include the ROM or other static storage device for storing static information and instructions for processor 201; a storage device 740, such as a magnetic disk or optical disk, may be provided for storing information and instructions. Communication interface 205 enables LPM server 101 to communicate with one or more communication networks 104 (e.g., cellular network) through use of the network link (wireless or wired). Using the network link, loyalty program management server 101 can communicate with one or more computing devices, and one or more servers of loyalty program redemption system 100.

Loyalty program redemption logic module 105 of loyalty program management server 101 may include instructions stored in RAM of memory 202, and includes requestor module 205, provider inventory accessing module 206, dynamic redemption optimization module 207 and redemption options identification module 208. Processor 201 uses executable instructions stored in requestor module 205 to identify a qualifying or optimal subset of the discounted inventory items along with associated perceived value indicators and loyalty program sponsors or providers related to loyalty program redemption transactions. Identification of the qualifying subset of discounted inventory items may be based on dynamically applying respective threshold values to the costs of redemption to the loyalty program provider and the perceived value indicators. In certain embodiments, the threshold value may be applied to identify only subsets of redemption options for inventory items which satisfy or provide a zero cost of redemption to the loyalty program provider.

Processor 201 uses executable instructions stored in provider inventory accessing module 206 to access, via communication network 104, from loyalty program provider (LPP) server devices 103a-n associated with respective loyalty program providers, a set of discounted inventory items of the targeted class of inventory items in accordance with the redemption request received. The discounted inventory items have discounted item values in accordance with the respective redemption item pricing databases as offered at LPP servers 103a-n by the loyalty program providers.

Processor 201 uses executable instructions stored in dynamic redemption optimization module 207 to determine, for each discounted inventory item, (i) a cost of the redemption that is incurred by the respective loyalty program provider in redeeming the request, and (ii) a perceived value indicator, as might be perceived by the loyalty program customer making the redemption request at client device 102. The determinations, or calculations, are made based at least in part on the respective discounted item values, the differential between full and discounted retail prices and the asset spend parameters associated with the redemption request. For example, the cost of the redemption transaction to the loyalty program provider relates to the discounted inventory item value rather than the standard retail price of a counterpart non-discounted inventory item. Further by way of illustration, the perceived value indicator may be determined as a relative value of the monetary or cash-equivalent benefit being received by the redeeming member or the discounted item value compared to the amount of points of the asset spend being redeemed in exchange by the requestor loyalty program member. For example, if a standard retail price of a hotel room is $300, and the discounted price offered by a loyalty program provider is $200, with a resultant price differential of ($300-$200) amounting to $100, for a points portion of the asset spend of 5,000 points, then the perceived value indicator corresponds to a value per point redeemed of ($100/5,000), or 0.02.

Processor 201 uses executable instructions stored in redemption options identification module 208 to identify a subset of the discounted inventory items which meet certain threshold values for the costs of redemption to the loyalty program provider/sponsor while simultaneously maximizing the perceived value indicators to the loyalty program requestor/member. The threshold values may be set dynamically in real time, and applied with different weightings in real time at LPM server 101. In some embodiments, the threshold values may be based on different combinations and relative weightings of the cost of redemption to the loyalty program providers and perceived value indicators to the redeemer, applied dynamically in real time to identify the qualifying subset of discounted inventory items for any given redemption transaction. Certain embodiments herein recognize that conventional approaches identify solutions where minimizing or eliminating the costs of redemptions to the loyalty program providers are diametrically opposed to a goal of achieving and delivering maximum value to a redeeming member, as measured by the perceived value indicators. In contrast to such conventional approaches wherein the costs of redemption to the loyalty program providers can be minimized or eliminated only to the detriment of providing maximum value to redeeming members as measured by the perceived value indicators, certain embodiments of the dynamic loyalty redemption methods and systems herein identify and provide solutions where, as the costs of redemptions to the loyalty program providers progressively decrease towards a zero cost, perceived value to a redeeming member progressively increase, as measured by the perceived value indicators.

In other embodiments, respective loyalty program providers may be identified along with their discounted inventory items within the identified subset of items that meet one, or any combination, of the multiple threshold criteria. The identified discounted inventory items, along with associated perceived value indicators and loyalty program providers may be forwarded from LPM server 101 via communication network 104 for presentation via requestor user interface module 106 at the requestor client device 102.

### Methodology

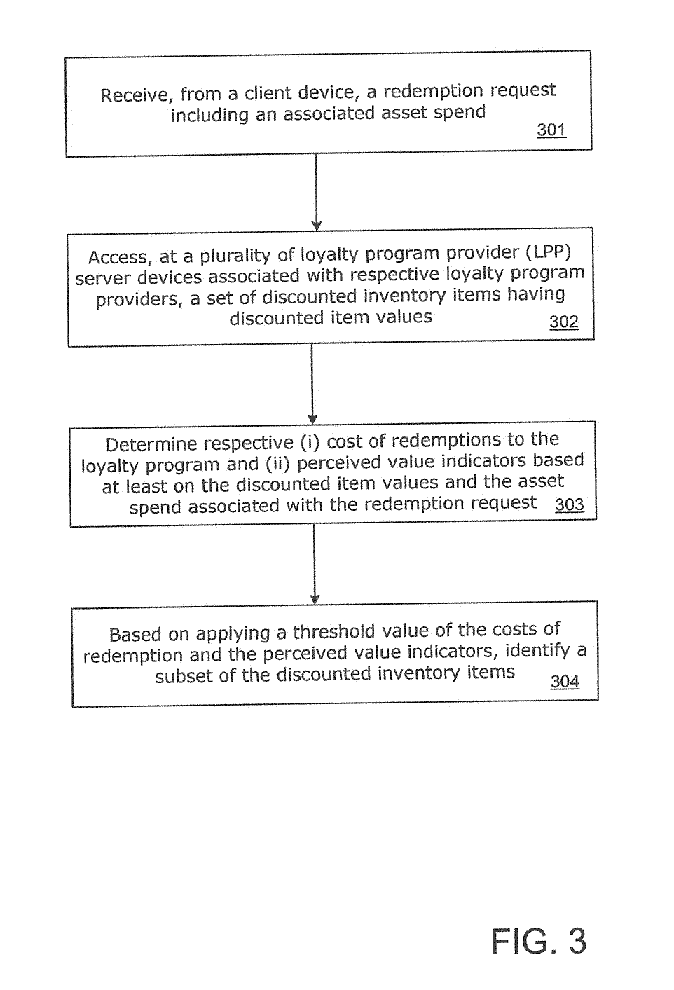

FIG. 3 provides an example method of operation of a dynamic loyalty program redemption system. In describing the example of FIG. 3, reference is made to the examples of FIGS. 1-2 for purposes of illustrating suitable components or elements for performing a step or sub-step being described.

Examples of method steps described herein relate to the use of LPM server 101 for implementing the techniques described herein. According to one embodiment, the techniques are performed by LPM server 101 in response to the processor 201 executing one or more sequences of one or more instructions pertaining to loyalty program redemption logic module 105 contained in memory 202. Such instructions may be read into memory 202 from machine-readable medium, such as memory storage devices. Execution of the sequences of instructions contained in the memory 202 causes the processor 201 to perform the process steps described herein. In alternative implementations, hard-wired circuitry may be used in place of or in combination with software instructions to implement examples described herein. Thus, the examples described are not limited to any particular combination of hardware circuitry and software.

At step 301, receiving, from requestor client device 102, a redemption request that specifies an asset spend for a redemption request. In one embodiment, the asset spend associated with the redemption request may be an amount of points, or travel miles, cumulatively earned and available for spending for a redemption request, combined with a cash monetary portion to be paid by the redeeming member of the loyalty program. The redemption request may also specify a class of inventory items to which it is targeted, such as, but not limited to, a travel ticket, a hotel room, a rental vehicle, a gift card or a merchandise item.

At step 302, accessing, via communication network 104, from loyalty program provider (LPP) server devices 103a-n associated with respective loyalty program providers, a set of discounted inventory items of the targeted class of inventory items for the redemption request. The discounted inventory items have discounted item values in accordance with the respective redemption item pricing databases as offered at LPP servers 103a-n by the loyalty program providers.

At step 303, determining, for each discounted inventory item, (i) a cost of the redemption that is incurred by the respective loyalty program provider in redeeming the request, and (ii) a perceived value indicator, as might be perceived by the loyalty program customer making the redemption request at client device 102. The determinations, or calculations, are made based at least in part on the respective discounted item values and the asset spend associated with the redemption request. For example, the cost of the redemption transaction to the loyalty program provider may relate to the discounted inventory item price rather than the standard retail price of a counterpart non-discounted inventory item. Further by way of illustration, the perceived value indicator may be determined as a relative value quotient of the price differential between discounted and full retail price, or a cash-equivalent or monetary value to be realized by the redeeming member, compared to a points portion of the asset spend being redeemed by the end user or member of the loyalty program. For example, if a standard retail price of a hotel room is $400 and the discounted price offered by a loyalty program provider is $200 in return for a redemption of 5,000 points, then the perceived value indicator corresponds to a quotient of ($200/5,000 points), or 0.02 (the $200 numerator being the price differential between full retail and discounted prices). In this case, where an asset spend comprising a cash portion of $200 along with the points portion of 5,000 points is exchanged by the redeeming member to acquire the $400 hotel room, a zero cost of redemption by the loyalty program provider results, since the $200 cash portion paid by the ember is equal to the $200 price discount between the full retail price and the discounted retail price. In this manner, in contrast to conventional approaches that identify solutions where minimizing or eliminating the costs of redemptions to the loyalty program providers are diametrically opposed to a goal of achieving and delivering maximum value to a redeeming member as measured by the perceived value indicators, embodiments of the dynamic loyalty redemption methods and systems herein identify and provide solutions whereas the costs of redemptions to the loyalty program providers may be a zero cost in association with maximizing perceived value to a redeeming member as measured by perceived value indicators.

At step 304, a subset of the discounted inventory items is identified which meet certain threshold value for the costs of redemption to the loyalty program provider/sponsor perceived value indicators to the loyalty program requestor/member. The threshold values may be set dynamically in real time, and applied with different weightings of relative importance in real time at LPM server 101. In yet another embodiment, different combinations of weightings of cost of redemption to the loyalty program provider and perceived value indicator may be applied dynamically in real time when identifying the qualifying subset of discounted inventory items for any given redemption transaction presented as a selection option to the redeemer.

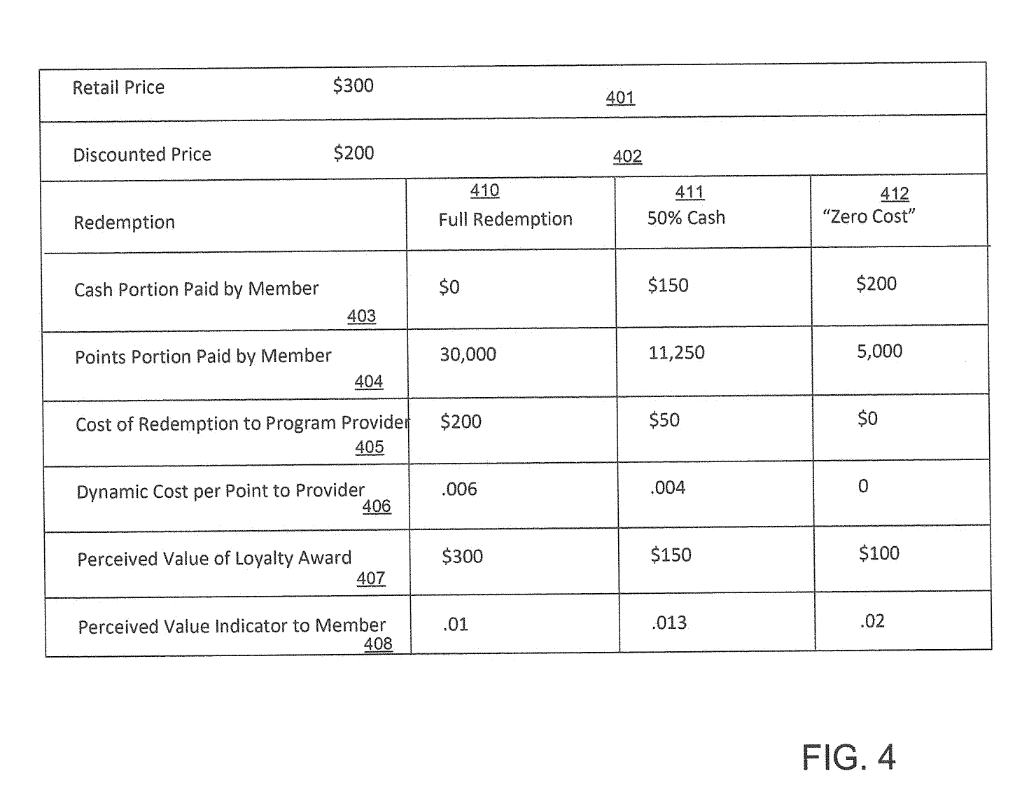

FIG. 4 illustrates an example instance of a solution set in operation of the dynamic loyalty program redemption system. Each discounted inventory item is associated with a full retail price 401 and a discounted inventory item price 402. The discounted inventory item price may be set based on a price differential between the full retail price 401 and the discounted price 402. In the particular example depicted, the price differential is $100, the difference between a full retail price of $300 and the discounted price of $200. A range of solution sets 410, 411 and 412 may be generated, based on various amounts and combinations of asset spend options made available to a redeemer or member to acquire the targeted inventory item, considered as a travel ticket in the particular case depicted. In contrast to conventional approaches that identify solutions where minimizing or eliminating the costs of redemptions to the loyalty program providers are diametrically opposed to a goal of achieving and delivering maximum value to a redeeming member as measured by the perceived value indicators, embodiments of the dynamic loyalty redemption methods and systems herein identify and provide solutions where, across solution sets 410, 411, 412, the costs of redemptions to the loyalty program providers may be progressively minimized to a zero cost while simultaneously and progressively maximizing perceived value to a redeeming member as measured by perceived value indicators. Particular 410, 411 and 412 solution set options are depicted for illustration purposes only, as those skilled in art will appreciate that numerous such options involving different combinations of asset spend points amounts with respective associated costs of redemptions may be offered and made available by loyalty program providers under the loyalty programs.

Still with reference to FIG. 4, the asset spend may comprise loyalty points accumulated by the end-user or loyalty program redeemer (also referred to herein as redeemer or member), or any combination of cash monetary portion 403 with loyalty points portion 404. Cost of redemption to the loyalty program provider 405 reflects the discounted price of the inventory item, or any portion thereof, that is being recognized as a liability of the loyalty program provider once a particular one of redemption transaction solution sets 410, 411, 412 is dynamically determined and presented for selection by the redeemer. Dynamic cost per point to provider 406 reflects that liability, alternatively expressed as a quotient based on the cost of redemption to the provider 405 relative to an amount of the loyalty points portion 404 as redeemed by the member. Perceived value of the loyalty award 407 is of the value as realized by the redeemer in acquisition the inventory item, in this case the amount saved by the member in redeeming loyalty points towards acquisition of a $300 full retail price travel ticket offered by the loyalty program provider for redemption under the loyalty program. Perceived value indicator 408 may be calculated as a quotient based on an actual savings from full retail price of $300 as realized relative to the amount of the loyalty points portion 404 of the asset spend by the end-user, member or redeemer under the loyalty program. A specific one, or specific ones, of solution sets 410, 411, 412 may include identification of the discounted inventory items and associated loyalty program providers.

In other embodiments, respective loyalty program providers may be identified along with their discounted inventory items within the identified subset of items that meet one, or any combination, of the multiple threshold criteria. The identified discounted inventory items, along with associated perceived value indicators and loyalty program providers may be forwarded from LPM server 101 via communication network 104 for presentation via requestor user interface module 106 at the requestor client device 102.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that any particular feature described either individually or as part of an embodiment can be combined with other individually described features, or parts of other embodiments, even if the other features and embodiments make no mention of the particular feature; for example, individual ones of the logic modules may alternatively be implemented within, or associated with, a memory of other devices of the system than described in example embodiments herein. Thus, the absence of describing combinations should not preclude the inventor from claiming rights to such combinations.

What is claimed is:

1. A method executed in a processor of a loyalty program management (LPM) server device, the method comprising:
receiving, from a client device, a redemption request including an associated asset spend;
accessing, at a plurality of loyalty program provider (LPP) server devices associated with respective loyalty program providers, a set of discounted inventory items having respective discounted item values in accordance with a price discount differential from a full retail price;
determining respective (i) cost of redemptions to the loyalty program providers and (ii) perceived value indicators based at least in part on the respective discounted item values and the asset spend associated with the redemption request; and
based on applying respective threshold values of at least one of the respective costs of redemption to the loyalty program providers and the respective perceived value indicators, identifying a subset of the discounted inventory items.

2. The method of claim 1 further comprising identifying a subset of the loyalty program providers associated with respective ones of the identified subset of the discounted inventory items.

3. The method of claim 1 wherein the asset spend associated with the redemption request comprises a redemption points portion and a monetary cash portion.

4. The method of claim 1 wherein the redemption request specifies a class of inventory items pertaining to the discounted inventory items.

5. The method of claim 4 wherein the class of inventory items consists of one of: a travel ticket, a hotel room, a rental vehicle, a gift card and a merchandise item.

6. The method of claim 3 wherein the perceived value indicator is determined based at least in part on the redemption points portion of the asset spend.

7. The method of claim 1 wherein the threshold value of the cost of redemption to the loyalty program provider comprises a zero cost

8. The method of claim 7 wherein the threshold value of the perceived value indicator is selected as a maximum value of the determined perceived value indicators.

9. The method of claim 1 further comprising forwarding at least one discounted inventory item from the identified subset for presentation at the client device.

10. The method of claim 9 further comprising forwarding the perceived value indicator associated with the at least one discounted item from the identified subset for presentation at the client device.

11. A loyalty program management (LPP) server system for managing asset redemptions in a loyalty program comprising:
a processor; and
a memory storing instructions, the instructions being executable by the processor to:
receive, from a client device, a redemption request including an associated asset spend;
access, at a plurality of loyalty program provider (LPP) server devices associated with respective loyalty program providers, a set of discounted inventory items having respective discounted item values in accordance with a price discount differential from a full retail price;
determine respective (i) cost of redemptions to the loyalty program providers and (ii) perceived value indicators based at least in part on the respective discounted item values and the asset spend associated with the redemption request; and
based on applying respective threshold values of the respective costs of redemption to the loyalty program providers and the respective perceived value indicators, identify a subset of the discounted inventory items.

12. The system of claim 11 wherein the memory further comprises instructions to identify a subset of the loyalty program providers associated with respective ones of the identified subset of the discounted inventory items.

13. The system of claim 11 wherein the asset spend associated with the redemption request comprises a redemption points portion and a monetary cash portion.

14. The system of claim 11 wherein the redemption request specifies a class of inventory items pertaining to the discounted inventory items.

15. The system of claim 11 wherein the class of inventory items consists of one of: a travel ticket, a hotel room, a rental vehicle, a gift card and a merchandise item.

16. The system of claim 13 wherein the perceived value indicator is determined based at least in part on the redemption points portion of the asset spend.

17. The system of claim 11 wherein the threshold value of the cost of redemption to the loyalty program provider comprises a zero cost.

18. The system of claim 17 wherein the threshold value of the perceived value indicator is selected as a maximum value of the determined perceived value indicators.

19. The system of claim 11 wherein the memory further comprises instructions to forward at least one discounted inventory item from the identified subset for presentation at the client device.

20. The system of claim 19 wherein the memory further comprises instructions to forward the perceived value indicator associated with the at least one discounted item from the identified subset for presentation at the client device.
